(19) United States
(12) Patent Application Publication
(10) Pub. No.: US 2003/0088454 A1
(43) Pub. Date: May 8, 2003

(54) System, method and computer program product for complaint report issue

(75) Inventor: Toshio Ueno, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/002,742

(22) Filed: Nov. 2, 2001

(51) Int. Cl. G06F 17/60

(52) U.S. Cl. 705/10

(57) ABSTRACT

A complaint-report-issuing system includes a master database section which holds product information related to a sales product and a report having no solution. The system periodically calculates points for each analysis-determination item used to analyze and determine the report on the basis of a result obtained by analyzing the product information and a preset condition for the result and totals the points of the analysis-determination items. The complaint-report-issuing system issues a complaint report of the report to a host center on the basis of the points totaled by the point calculation section and a preset point range for complaint-report-issuing.

### BACKGROUND OF THE INVENTION

1 Field of the Invention

The present invention relates to a report-issuing method and system for issuing a complaint report of a complaint related to a product under a main office that provides a technical service, and a computer-readable storage medium which stores a program for operating the system.

2 Description of the Related Art

In recent years, many large corporations sell products such as copying machines and facsimile apparatuses throughout the world. Such corporations establish local affiliates that handle different market areas and also establish, under each local affiliate, agencies and dealers, thereby forming a sales network. Such a network enables communications between local head office and the technical service department of the head office, for providing technical services, and connecting each local company to the agencies and dealers.

The head office provides services such as repair and maintenance for sales products by, e.g., a field service technician who works for a dealer. For technical service, field service technician creates a report that describes certain matters, such as a service result, the cause of a complaint, and a solution request if he/she cannot solve the problem. The field service technician sends the report to the local head office through the dealer using, e.g., E-mail. Upon receiving this report, the local head office inputs the predetermined matters to a server. If no solution can be detected, the local head office sends the report to the technical service department as a complaint report.

Since the technical service department receives all complaint reports from local head office that handle various markets in different areas, an enormous number of complaints are received, and complaints build up in the technical service department.

Hence, each local head office need to send a report that satisfies a predetermined condition to the technical service department as a complaint report, instead of sending all reports as complaint reports.

### BRIEF SUMMARY OF THE INVENTION

A complaint-report-issuing system comprises a master database section which holds product information related to a sales product and a report having no solution, a point calculation section which periodically calculates points for each analysis-determination item used to analyze and determine the report on the basis of a result obtained by analyzing the product information and a preset condition for the result and totals the points of the analysis-determination items, and a complaint report issue section which issues a complaint report of the report to a host center on the basis of the point totaled by the point calculation section and a preset point range for complaint report issue.

In a complaint-report-issuing method, points for each analysis-determination item used to analyze and determine a report having no solution are periodically calculated on the basis of a result obtained by analyzing product information related to a sales product and a preset condition for the result, and the points calculated for the analysis-determination items are totaled. A complaint report of the report is issued to a host center on the basis of the totaled points and a preset point range for complaint-report-issuing.

### BRIEF DESCRIPTION OF THE SEVERAL VIEWS OF THE DRAWING

The accompanying drawings, which are incorporated in and comprise a part of the specification, illustrate presently embodiments of the invention, and together with the general description given above and the detailed description of the embodiments given below, serve to explain the principles of the invention.

FIG. 1 is a view showing the arrangement of a network according to an embodiment of the present invention;

FIG. 2 is a block diagram showing the configuration of a complaint-report-issuing system according to the embodiment;

FIG. 3 is a table showing analysis-determination items used to issue a report by the complaint-report-issuing system according to the embodiment;

FIG. 4 is a table showing points calculated from analysis-determination of the delivery situation of a defective service part in the embodiment;

FIG. 5 is a table showing points calculated from analysis-determination of the machine market operation reliability of a defective product in the embodiment;

FIG. 6 is a table showing points calculated from analysis-determination of the report situation to the call center of the occurrence of complaints that are the same as a given complaint in the embodiment;

FIG. 7 is a table showing points calculated from analysis-determination of the identical problem situation of maintenance service information about the occurrence of complaints that are the same as a given complaint in the embodiment;

FIG. 8 is a table showing points calculated from analysis-determination of the setup report situation about the occurrence of complaints that are the same as a given complaint in the embodiment;

FIG. 9 is a table showing points calculated from analysis-determination of the compensation situation of a defective product in the embodiment;

FIG. 10 is a table showing points calculated from analysis-determination of the product sales situation and inventory situation of a defective product for the last month and for the total period in the embodiment;

FIG. 11 is a table showing points calculated from analysis-determination of the download situation of firmware and drivers corresponding to a complaint in the embodiment;

FIG. 12 is a table showing a weight setting table according to the embodiment;

FIG. 13 is a table showing a complaint-report-issuing table according to the embodiment;

FIG. 14 is a flowchart showing the flow of processing executed by the complaint-report-issuing system according to the embodiment; and

FIG. 15 is a view showing detailed contents of a complaint report issued by the complaint-report-issuing system according to the embodiment.

### DETAILED DESCRIPTION OF THE INVENTION

An embodiment of the present invention will be described below with reference to the accompanying drawing.

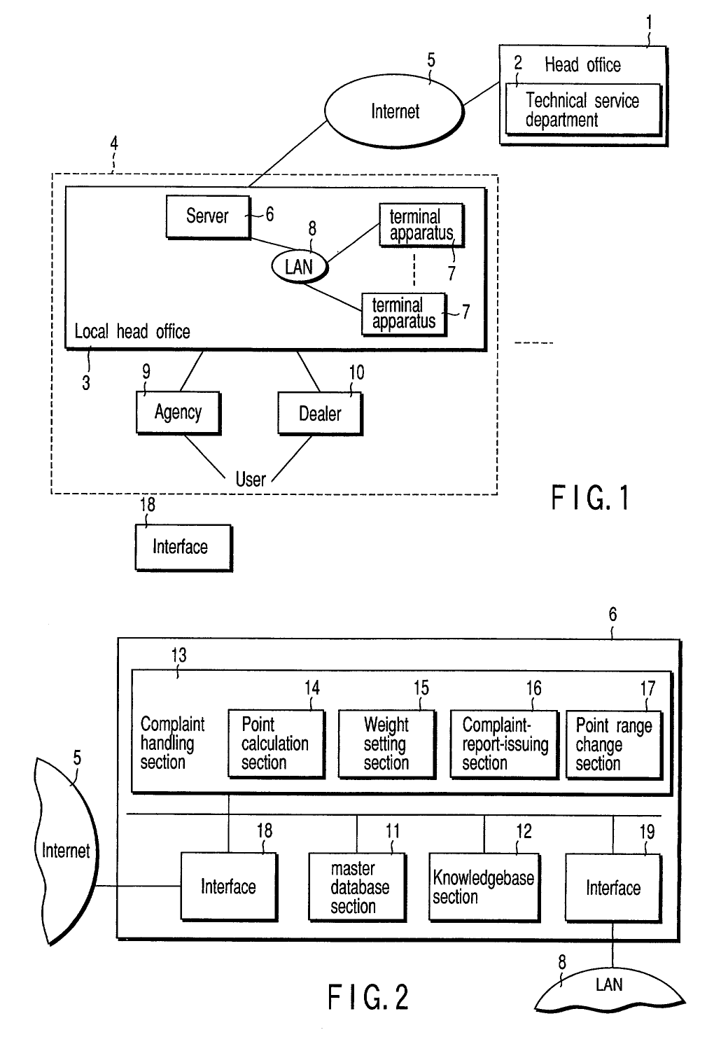

FIG. 1 is a view showing the arrangement of a network. A head office 1 has a technical service department 2 and is located at the uppermost position of a sales network for selling products such as copying machines and facsimile apparatuses. A local head office 3 handles a market area 4. Many local head office 3 are established for different market areas. The head office 1 and each local head office are communicably connected through the Internet 5. The local head office 3 has a server 6 serving as a complaint-report-issuing system. This server 6 is connected to, e.g., terminal apparatuses 7, with which operators in the local head office 3 input reports, through a LAN (Local Area Network) 8. The local head office 3 is also connected to an agency 9 and dealer 10, which are established in the market area 4 handled by the local head office, through communication lines.

The technical service department 2 in the head office 1 collects information through the network having the above arrangement, thereby managing various kinds of information including reports about sales products. When a complaint sent from a local head office such as the local head office 3 to the technical service department 2 is solved, the complaint is transmitted to each local head office through the Internet 5 and held in the server 6 installed in each local head office.

FIG. 2 is a block diagram showing the arrangement of the server 6 serving as a complaint-report-issuing system. The server 6 has a master database (MDB) section 11, knowledgebase (KB) section 12, complaint handling (CH) section 13, and interfaces 18 and 19. The CH section 13 includes a point calculation (PC) section 14, weight setting (WE) section 15, complaint-report-issuing (CRI) section 16, and point range change (PRC) section 17.

The MDB section 11, KB section 12, CH section 13, and interfaces 18 and 19 are connected through a bus line. The interface 18 is used to connect the Internet 5. The interface 19 is used to connect the LAN 8 of the local head office 3.

The MDB section 11 backs up a report received by the terminal apparatus 7 and holds information related to a product sales in the relevant market area 4 as product information. When new information is collected, the MDB section 11 updates and holds the product information. The MDB section 11 holds, as product information, e.g., the number of delivered service parts, the number of delivered products, the total number of copies, the number of service calls, the number of reports (inquiries), the number of maintenance result reports, the number of setup reports, the total amount of compensation, the sales record for the last month, the sales forecast for the previous month, the sales record for the total period, the sales forecast for the total period, and the number of times of download of firmware and drivers corresponding to a complaint for each sales product. The MDB section 11 also holds, as product information, e.g., the total number of copies, the number of service calls, the number of reports (inquiries), the number of maintenance result reports, and the number of setup reports for all the sales products.

The KB section 12 holds solutions to complaints transmitted from the technical service department 2 through the Internet 5.

Upon receiving a report from the terminal apparatus 7, the CH section 13 determines whether a solution to a complaint specified by the report is held by the KB section 12. If no solution is held, the report is stored in the MDB section 11 as a report for which no solution is held.

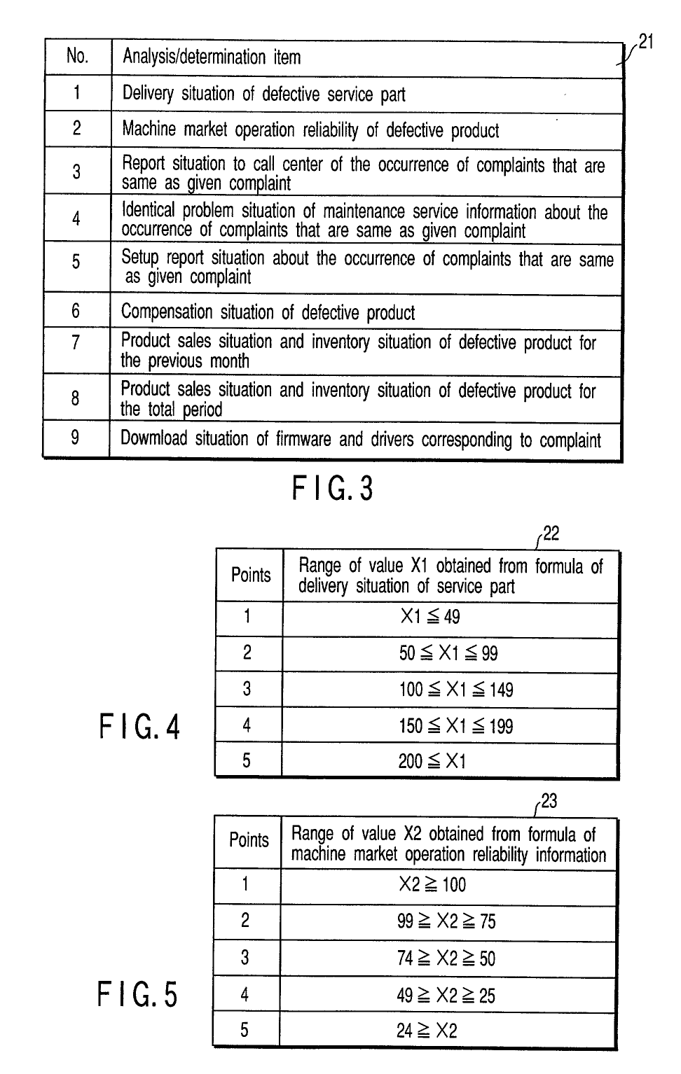

The PC section 14 periodically analyzes and determines each report held by the MDB section 11, for which no solution is held. The period for this analysis-determination can be freely set. As items to be used for this analysis-determination, nine analysis-determination items are prepared in, e.g., a table 21 shown in FIG. 3. Item No. (number) 1 is the delivery situation of a defective service part. Item No. 2 is the machine market operation reliability of a defective product. Item No. 3 is the report situation to the call center of the occurrence of complaints that are the same as a given complaint. Item No. 4 is the identical problem report situation of maintenance service information about the occurrence of complaints that are the same as a given complaint. Item No. 5 is the setup report situation about the occurrence of complaints that are the same as a given complaint. Item No. 6 is the compensation situation of a defective product. Item No. 7 is the product sales situation and inventory situation of a defective product for the previous month. Item No. 8 is the product sales situation and inventory situation of a defective product for the total period. Item No. 9 is the download situation of firmware and drivers corresponding to a complaint.

The PC section 14 also assigns 1-5 points for each analysis-determination in a target market using formulas to be described below and tables used to calculate a point from calculation results of the formulas set for each analysis-determination item. In each analysis-determination item, when the complaint must be layer-shifted, a high number of points is calculated. The analysis-determination items will be described below.

The delivery situation of a defective service part, which is analyzed and determined in analysis-determination item No. 1, is obtained by, e.g., formula: (the number of delivered service parts/the number of delivered products using the parts)×100. Assume that the calculation result of this formula is X1%. The PC section 14 calculates a point on the basis of a table 22 shown in FIG. 4 that shows points calculated from the value X1. When X1≦49, the PC section 14 calculates 1 point. When 50≦X1≦99, the PC section 14 calculates 2 points. When 100≦X1≦149, the PC section 14 calculates 3 points. When 150≦X1≦199, the PC section 14 calculates 4 points. When 200≦X1, the PC section 14 calculates 5 points.

The machine market operation reliability of a defective product, which is analyzed and determined in analysis-determination item No. 2, is obtained by, e.g., calculating the mean number of service call occurrence interval copies (MCBSC) by the total number of copies for all machines/the total number of service calls and comparing the calculated value with the average for another product. That is, the machine market operation reliability of a defective product is obtained by formula: (the MCBSC of the product/the mean MCBSC of another product)×100. Assume that the calculation result of this formula is X2%. The PC section 14 calculates a point on the basis of a table 23 shown in FIG. 5 that shows points calculated from the value X2. When X2≧100, the PC section 14 calculates 1 point. When 99≧X2≧75, the PC section 14 calculates 2 points. When 74≧X2≧50, the PC section 14 calculates 3 points. When 49≧X2≧25, the PC section 14 calculates 4 points. When 24≧X2, the PC section 14 calculates 5 points.

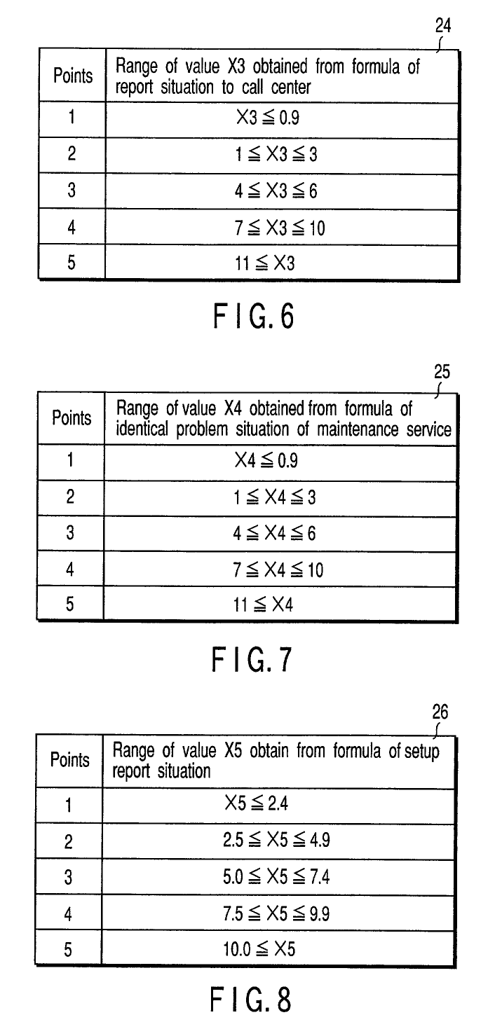

The report situation to the call center of the occurrence of complaints that are the same as a given complaint, which is analyzed and determined in analysis-determination item No. 3, is obtained by, e.g., formula: {the number of reports (inquiries) about complaints that are the same as a given complaint/the total number of reports (inquiries)}×100. Assume that the calculation result of this formula is X3%. The PC section 14 calculates a point on the basis of a table 24 shown in FIG. 6 that shows points calculated from the value X3. When X3≦0.9, the PC section 14 calculates 1 point. When 1≦X3≦3, the PC section 14 calculates 2 points. When 4≦X3≦6, the PC section 14 calculates 3 points. When 7≦X3≦10, the PC section 14 calculates 4 points. When 11≦X3, the PC section 14 calculates 5 points.

The identical problem situation of maintenance service information about the occurrence of complaints that are the same as a given complaint, which is analyzed and determined in analysis-determination item No. 4, is obtained by, e.g., formula: (the number of maintenance result reports of the complaint/the total number of maintenance result reports)×100. Assume that the calculation result of this formula is X4%. The PC section 14 calculates a point on the basis of a table 25 shown in FIG. 7 that shows points calculated from the value X4. When X4≦0.9, the PC section 14 calculates 1 point. When 1≦X4≦3, the PC section 14 calculates 2 points. When 4≦X4≦6, the PC section 14 calculates 3 points. When 7≦X4≦10, the PC section 14 calculates 4 points. When 11≦X4, the PC section 14 calculates 5 points.

The setup report situation about the occurrence of complaints that are the same as a given complaint, which is analyzed in analysis-determination item No. 5, is obtained by, e.g., formula: (the number of setup reports of the complaint/the total number of setup reports)×100. Assume that the calculation result of this formula is X5%. The PC section 14 calculates a point on the basis of a table 26 shown in FIG. 8 that shows points calculated from the value X5. When X5≦2.4, the PC section 14 calculates 1 point. When 2.5≦X5≦4.9, the PC section 14 calculates 2 points. When 5.0≦X5≦7.4, the PC section 14 calculates 3 points. When 7.5≦X5≦9.9, the PC section 14 calculates points. When 10.0≦X5, the PC section 14 calculates 5 points.

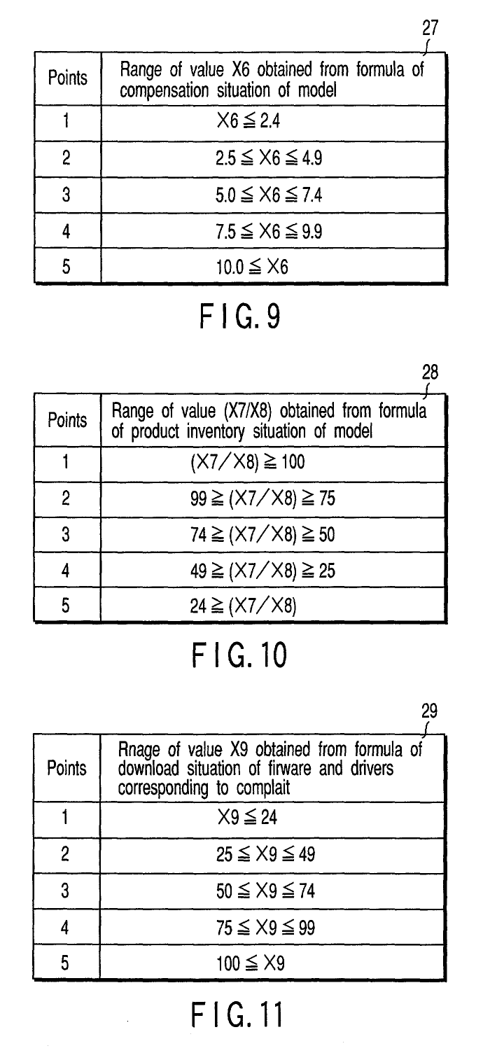

The compensation situation of a defective product, which is analyzed and determined in analysis-determination item No. 6, is obtained by, e.g., formula: (the total amount of compensation of the product/the total amount of compensation of all products)×100. Assume that the calculation result of this formula is X6%. The PC section 14 calculates a point on the basis of a table 27 shown in FIG. 9 that shows points calculated from the value X6. When X6≦2.4, the PC section 14 calculates 1 point. When 2.5≦X6≦4.9, the PC section 14 calculates 2 points. When 5.0≦X6≦7.4, the PC section 14 calculates 3 points. When 7.5≦X6≦9.9, the PC section 14 calculates 4 points. When 10.0≦X6, the PC section 14 calculates 5 points.

The product sales situation and inventory situation of a defective product for the previous month, which is analyzed and determined in analysis-determination item No. 7, is obtained by, e.g., formula: (the sales record of the product for a month/the sales forecast of the product for a month)×100. Assume that the calculation result of this formula is X7%. The PC section 14 calculates a point on the basis of a table 28 shown in FIG. 10 that shows points calculated from the value X7. When X7≧100, the PC section 14 calculates 1 point. When 99≧X7≧75, the PC section 14 calculates 2 points. When 74≧X7≧50, the PC section 14 calculates 3 points. When 49≧X7≧25, the PC section 14 calculates 4 points. When 24≧X7, the PC section 14 calculates 5 points.

The product sales situation and inventory situation of a defective product for the total period, which is analyzed and determined in analysis-determination item No. 8, is obtained by, e.g., formula: (the sales record of the product in the total period/the sales forecast of the product in the total period)×100. Assume that the calculation result of this formula is X8%. The PC section 14 calculates a point in the same value range as that shown in FIG. 10 for the above-described product sales situation and inventory situation for the previous month.

The download situation of firmware and drivers corresponding to a complaint, which is analyzed and determined in analysis-determination item No. 9, is obtained by, e.g., formula: (the number of times of download of firmware and drivers corresponding to the complaint/the number of delivered products)×100. Assume that the calculation result of this formula is X9%. The PC section 14 calculates a point on the basis of a table 29 shown in FIG. 11 that shows points calculated from the value X9. When X9≧24, the PC section 14 calculates 1 point. When 25≦X9≦49, the PC section 14 calculates 2 points. When 50≦X9≦74, the PC section 14 calculates 3 points. When 75≦X9≦99, the PC section 14 calculates 4 points. When 100≦X9, the PC section 14 calculates 5 points.

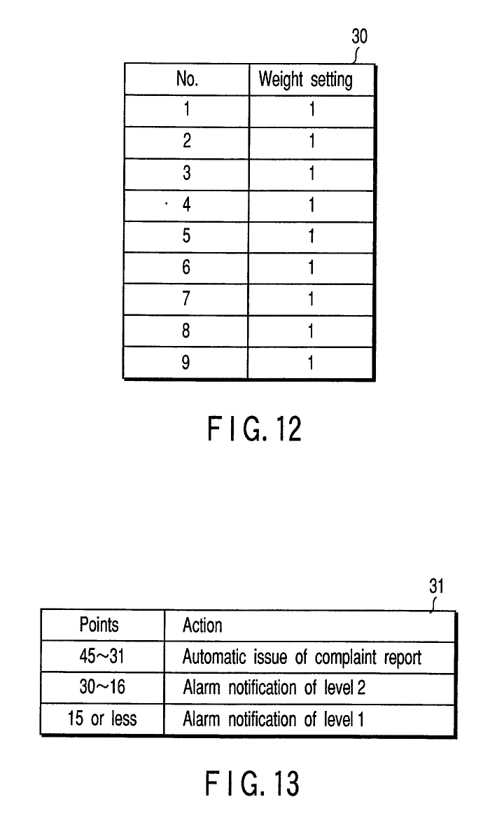

The WE section 15 can set a weight for each analysis-determination item to calculate a point in the above-described way. This weighting is done by, e.g., changing settings in a weight setting table 30 as shown in FIG. 12. In this embodiment, the weights for all analysis-determination items are uniformly set to 1. For example, when the weight for analysis-determination item No. 1 is set to 2, the PC section 14 doubles one of points 1 to 5 calculated from the analysis-determination item. The weight is changed by the operator in the local head office.

The PC section 14 also totals the points calculated in the above-described manner for the respective analysis-determination items to calculate the total point.

The CRI section 16 issues a complaint report to the technical service department 2 or sends an alarm notification to the terminal apparatus 7 on the basis of a complaint-report-issuing table 31 shown in FIG. 13 from the total point calculated by the PC section 14. The complaint-report-issuing table 31 is set such that when the total point is 45 to 31, a complaint report is issued to the technical service department 2, when the total point is 30 to 16, an alarm notification of level 2 is sent to the terminal apparatus 7, and when the total point is 15 or less, an alarm notification of level 1 is sent to the terminal apparatus. The alarm of level 2 alarms that the start of processing for a complaint specified by the received report should be prepared for. The alarm of level 1 alarms that processing for a complaint specified by the received report need not be started immediately.

When the operator executes weighting by changing settings of the weight setting table 30, the PRC section 17 calculates the total point by totaling the points calculated for the respective analysis-determination items obtained by changing the weight settings and divides the total point by, e.g., 3 for point rank setting to change the point range of the complaint-report-issuing table 31.

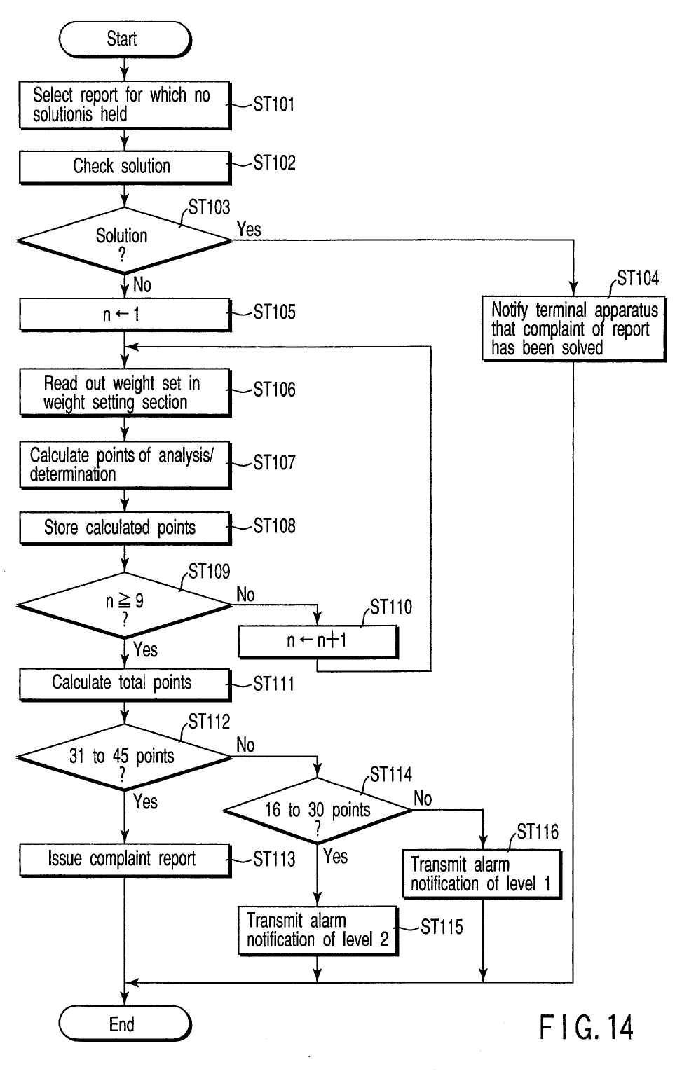

The flow of processing executed by the server 6 having the above arrangement to periodically analyze and determine a report held by the MDB section 11, for which no solution is present, will be described below with reference to FIG. 14.

In step ST101, one report held by the MDB section 11 as a report having no solution is read out. In step ST102, the CH section 13 determines whether a solution to this report is held on the basis of the solutions held by the KB section 12. If the CH section 13 determines in step ST103 that the KB section 12 holds the solution, in step ST104, the readout report is deleted from the reports having no solutions in the MDB section 11, and the terminal apparatus 7 is notified that the complaint of the report is solved.

If it is determined in step ST103 that no solution is held by the KB section 12, the PC section 14 executes processing of calculating the point of the readout report in steps ST105 to ST110.

First, in step ST105, a variable N representing the No. (number) of analysis-determination item is set to 1. In step ST106, the weight set for analysis-determination item No. 1 is read out from the weight setting table 30. In step ST107, a point is calculated on the basis of the readout weight and analysis-determination of the service part delivery situation. In step ST108, the calculated points is temporarily stored in, e.g., a memory.

Next, it is determined in step ST109 whether the variable N is 9 or more. If it is determined in step ST109 that the variable is less than 9, the variable N is incremented by one in step ST110. The processing in steps ST106 to ST109 is repeated until it is determined that the variable N is 9 or more. With this processing, points of all the respective analysis-determination items are calculated.

If it is determined in step ST109 that the variable is 9 or more, in step ST111, the PC section 14 totals the points of the analysis-determination items, which are stored in the memory, to calculate the total points.

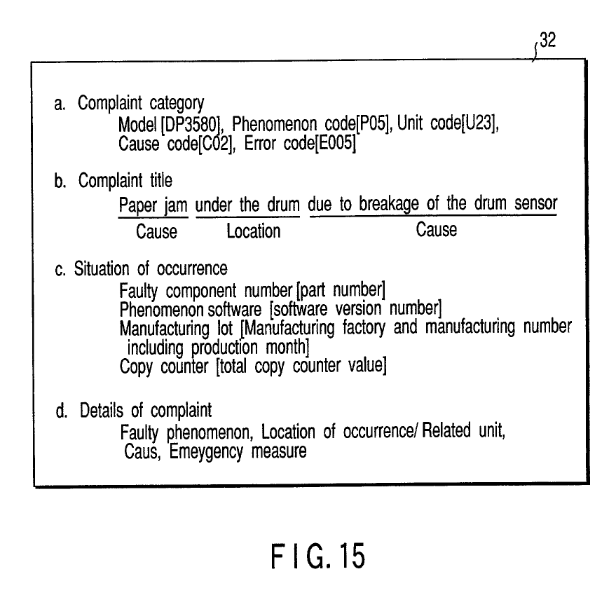

In step ST112, the CRI section 16 determines whether the calculated total point is 45 to 31. If YES in step ST112, the CRI section 16 reads out necessary information from the MDB section 11, creates a complaint report, and issues the complaint report to the technical service department 2 in step ST113. FIG. 15 shows detailed contents of items a, b, c, and d contained in the complaint report. The item a is a complaint category including a product model number, problem type code, unit code, cause code, and error code. The item b is a complaint title and is formed as a phrase that combines pieces of item definition information such as a phenomenon, location, and cause. Examples other than the complaint title shown in FIG. 15 are “dark copy image due to poor adjustment in optical unit” and “abnormal noise from drive gear in fuser unit”. The item c is a situation of the occurrence including a manufacturing number, software version number, defective component number, and total copy counter value. The item d is complaint definition information obtained from details of the complaint and is prepared as a free description including items such as a problematic phenomenon, occurrence location, cause, and measure.

If No in step ST112, it is determined in step ST114 whether the total point is 30 to 16. If YES in step ST114, an alarm notification of level 2 is transmitted to the terminal apparatus 7 in step ST115. If No in step ST114, an alarm notification of level 1 is transmitted to the terminal apparatus 7 in step ST116. The processing shown in FIG. 14 is periodically executed for all reports without any solutions, which are held by the MDB section 11.

Upon receiving the automatically issued complaint report, an information system installed in the technical service department 2 displays a message representing that the complaint report has been received, on the display section of a terminal apparatus or the like, which can be connected to the Internet 5, to draw attention to this fact.

According to this embodiment, the server 6 periodically reads out reports having no solutions, which are held by the MDB section 11. If a solution to the complaint of a report is obtained, a message representing it is displayed on the terminal apparatus 7. If no solution to the complaint of the report is held by the KB section 12, the PC section 14 calculates the points of each analysis-determination item and totals the points. On the basis of the total points and complaint-report-issuing table 31, if the total points is 45 to 31, the CRI section 16 automatically issues a complaint report to the technical service department 2. If the total points is 30 to 16, the CRI section 16 transmits an alarm notification of level 2 to the terminal apparatus 7. If the total points is 15 or less, the CRI section 16 transmits an alarm notification of level 1 to the terminal apparatus 7 and displays the alarm on the display section of the terminal apparatus 7. Hence, for a report that satisfies the condition to layer-shift a report, which is set in the complaint-report-issuing table 31, a complaint report is automatically created and transmitted to the technical service department 2.

In addition, since the number of complaint reports sent to the technical service department 2 in the head office 1 decreases, the complaint handling efficiency of the information system in the technical service department 2 can be improved.

Furthermore, since weight settings of the WE section 15 can freely be changed in the local head office 3, rank assignment can be done with a weight increased on any one of the analysis-determination items desired by the local head office or technical service department 2.

In addition, the points of each complaint having no solution, which is held by the MDB section 11, is periodically calculated. For this reason, even when an analysis-determination item in the server 6, the formula used to calculate the points, point range setting, or settings in the complaint report issue table 31 are changed in accordance with the requirement from the technical service department 2, or even when information in the MDB section 11 or KB section 12 is updated, the server 6 can automatically periodically create a report that must be layer-shifted or a complaint report and issues the complaint report to the information system in the technical service department 2 in accordance with the changed settings.

The present invention can be applied not only to a worldwide technical service network but also to a plurality of domestic market areas in a single country. That is, the present invention can be applied to a case wherein an organization corresponding to the local head office 3 is present in each state, and an organization corresponding to the head office 1 manages the local head office in the whole country. The MDB section 11, KB section 12, CH section 13, PC section 14, WE section 15, CRI section 16, and PRC section 17 are all provided in the server 6. However, the present invention is not limited to this. The present invention can also be applied to a case wherein these components are provided in a plurality of servers which are connected to each other.

FIG. 14 is a flowchart of the system and the method according to an embodiment of invention. Each block of the flowchart, and combinations of blocks in the flowchart, can be implemented by computer program instructions. These computer program instructions may be loaded onto a computer program or other programmable apparatus to produce a machine. These computer program instructions may also be stored in a computer-readable memory that can direct a computer or other programmable apparatus to function in a particular manner. The computer program instructions may also be loaded onto a computer or other programmable apparatus to cause a series of operational steps to be performed on the computer or other programmable apparatus to produce a computer implemented process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A complaint-report-issuing system comprising:
a master database section which holds product information related to a sales product and a report having no solution;
a point calculation section which periodically calculates points for each analysis-determination item used to analyze and determine the report on the basis of a result obtained by analyzing the product information and a preset condition for the result and totals the points of the analysis-determination items; and
a complaint-report-issuing section which issues a complaint report of the report to a host center on the basis of the point totaled by said point calculation section and a preset point range for complaint-report-issuing.

2. A system according to claim 1, further comprising a weight setting section which sets for each analysis-determination item a weight on the points calculated on the basis of the preset condition for the result from the result obtained by analyzing the product information.

3. A system according to claim 1, wherein one of the analysis-determination items is a delivery situation of a defective service part.

4. A system according to claim 1, wherein one of the analysis-determination items is a machine market operation reliability of a defective product.

5. A system according to claim 1, wherein one of the analysis-determination items is a report situation to a call center of the occurrence of complaints that are the same as a given complaint.

6. A system according to claim 1, wherein one of the analysis-determination items is an identical problem situation of maintenance service information about the occurrence of complaints that are the same as a given complaint.

7. A system according to claim 1, wherein one of the analysis-determination items is a setup report situation about the occurrence of complaints that are the same as a given complaint.

8. A system according to claim 1, wherein one of the analysis-determination items is a compensation situation of a defective product.

9. A system according to claim 1, wherein one of the analysis-determination items is a product sales situation and inventory situation of a defective product in a predetermined period.

10. A system according to claim 1, wherein one of the analysis-determination items is a download situation of firmware and drivers corresponding to a complaint.

11. A complaint-report-issuing method comprising:
periodically calculating points for each analysis-determination item used to analyze and determine a report having no solution on the basis of a result obtained by analyzing product information related to a sales product and a preset condition for the result;
totaling the points calculated for the analysis-determination items; and
issuing a complaint report of the report to a host center on the basis of the totaled points and a preset point range for complaint-report-issuing.

12. A method according to claim 11, further comprising changing for each analysis-determination item setting of weighting on the points calculated on the basis of the preset condition for the result from the result obtained by analyzing the product information.

13. A method according to claim 11, wherein one of the analysis-determination items is a delivery situation of a defective service part.

14. A method according to claim 11, wherein one of the analysis-determination items is a machine market operation reliability of a defective product.

15. A method according to claim 11, wherein one of the analysis-determination items is a report situation to a call center of the occurrence of complaints that are the same as a given complaint.

16. A method according to claim 11, wherein one of the analysis-determination items is an identical problem situation of maintenance service information about the occurrence of complaints that are the same as a given complaint.

17. A method according to claim 11, wherein one of the analysis-determination items is a setup report situation about the occurrence of complaints that are the same as a given complaint.

18. A method according to claim 11, wherein one of the analysis-determination items is a compensation situation of a defective product.

19. A method according to claim 11, wherein one of the analysis-determination items is a product sales situation and inventory situation of a defective product in a predetermined period.

20. A method according to claim 11, wherein one of the analysis-determination items is a download situation of firmware and drivers corresponding to a complaint.

21. A computer program product for complaint-report issue, comprising:
a computer-readable storage medium having computer-readable program code means embodied in said medium, said computer-readable program code means comprising:
computer readable program code means for periodically calculating points for each analysis-determination item used to analyze and determine a report having no solution on the basis of a result obtained by analyzing product information related to a sales product and a preset condition for the result;
computer readable program code means for totaling the points calculated for the analysis-determination items; and
computer readable program code means for issuing a complaint report of the report to a host center on the basis of the totaled points and a preset point range for complaint-report-issuing.
